(19) United States
(12) Patent Application Publication
(10) Pub. No.: US 2004/0108625 A1
(43) Pub. Date: Jun. 10, 2004

(54) Pneumatically assisted contour bonding system and formed laminated products produced thereby

(76) Inventors: Jerry R. Moder, Marysville, OH (US); Calvin D. Nyeboer, Holland, MI (US)

Correspondence Address: PORTER WRIGHT MORRIS & ARTHUR, LLP, INTELLECTUAL PROPERTY GROUP, 41 SOUTH HIGH STREET, 28TH FLOOR, COLUMBUS, OH, 43215

(21) Appl. No.: 10/313,398

(22) Filed: Dec. 6, 2002

(51) Int. Cl. B29C 51/10

(52) U.S. Cl. 264/510; 425/387.1; 425/90

(57) ABSTRACT

A system for producing a thermoformed contour trim component having enhanced finish and density characteristics in which a face good is laminated to an adhesive coated substrate in a molding process using cooperative shells A and B in which a positive gas pressure is applied to a mold shell such that the adhesive surface of the substrate and a face good and/or laminate layers in an assembly are directed into contact with a bonding force sufficient to bond the layers.

### FIELD OF THE INVENTION

The present invention relates to molded and contoured components surfaced with a sheet material such as a vinyl, cloth, leather or foil and particularly to laminate trim systems for commercial transportation vehicles, such as heavy equipment highway tractors and trucks, including interior soft trim headliners, wall panels, pillar covers and the like.

### BACKGROUND

Surfaced molded components used in the interior finish of heavy trucks typically include a thermoformable structural backing, such as a filled composite hemp/fiber board or the like, that is covered with a decorative or protective fabric, leather or polymeric sheet material. Such components are typically formed using a thermal or compression molding process that forms and bonds a backing and covering between first and second molds. The components are clamped into a frame, heated, then formed in the mold as the cover material is bonded to the front surface of the component backing by an adhesive coating on the backing surface. Additional laminate layers may be included in the component structure.

In the manufacture of such components, a mechanical compression process involving cooperative male and female molds is frequently used that forms the board backing and squeezes the sheet material into contact with the adhesive surface of the backing. Usually, to obtain good bonding, heat and a high compression between the mold pieces is required to press the backing and covering together and to compensate for thickness variations resulting from stretching and thinning characteristics of a material when the material is contoured. Mechanical compression processes may create gaps, wrinkles, and inconsistencies in the sheet surface covering; and with highly contoured components, excessive stretching may cause tears in the surface. Similarly with mechanical compression processes, limitations in the fiberboard material used for a backing may result in internal creases or gaps in the thickness of the backing, compromising structural integrity and limiting design opportunities. Creases, a loss of definition in surface designs, such as grain and plushness, and thinning and tearing of the covering material may occur due to the stretching of the material over an obtuse curve and compression at acute curves.

It is an object of the invention to maximize surface bonding between laminate layers by applying gas pressure to one or more exterior facing surface of a laminate assembly that is being molded. The invention adapts to varying thicknesses and varying densities in the end product laminate and produces a component free of voids and wrinkles and a smooth and consistent cover surface supported by the backing. The invention provides improved molded and contoured components surfaced with a sheet material and a pressure contour bonding system in which a thermoformable backing board or substrate is molded and sheet laminate material(s), such as a face good, is/are bonded thereto in the forming process. In contrast with mechanical compression processes, the pneumatically assisted process described herein provides a cost effective solution to accommodate variations in material thickness or density resulting when materials are stretched into shape in a forming process using cooperative mold halves. Quality problems that are more prevalent in deeper draw parts with aggressive side wall angles (approaching 90°) are avoided. A physical or mechanical compression approach must “smash” the thickest sections down before contact is made with the thinnest areas and it can not be accurately predicted where the materials thin, or exactly how much, in the compression process. In the pneumatically assisted process described herein, density inconsistencies through the thickness of the formed laminate are accommodated and a laminate with improved properties results.

### BRIEF DESCRIPTION OF THE DRAWINGS

FIG. 1 is a tool cross section, showing companion mold pieces enclosing the substrate and face good.

FIG. 2 is a detail of section 2→←2 of FIG. 1 showing details of the pressure contour bonding system of the invention.

FIGS. 3A and 3B are respectively a perspective and cross section view of a trim panel showing a face good bonded to a PPF or polypropylene/foam based material substrate having a relief indentation therein defining an accessory opening.

FIG. 4 illustrates steep side walls in a component being molded, showing the materials at their thinnest and the inability to achieve 1:1 movement on the compression tool.

### DESCRIPTION

In brief, the invention provides a method for simultaneously forming (stretch) and bonding multiple layers of flat (sheet) materials, namely, a rigid/semi-rigid substrate and a flexible facing material, together and the products produced thereby. The process is applicable to multiple layers of materials, for example, two or three or more layers may be bonded when the interface between surfaces of adjacent layers includes an adhesive to effect a bond. Depending on design and other factors related to a predetermined laminate assembly, an adhesive may be coated on one or more surface of a laminate layer; the adhesive may be precoated or applied in situ. The thickness range of potential substrate bases for the component is from approximately 1 mm to approximately 6 mm. Example materials include solids, for example, PE, ABS, PP, and the like, as well as composites such as IBC (Indiana Bio Composites), PPF (polypropylene foam), Superlite, and others. More generally substrate base materials may be characterized as having a polymer base and/or a filler that imparts strength such as glass, hemp, and/or other additives, for example, that strengthen the material skin. Face goods used in the assembly may typically range in thickness from about 0.3 mm to about 1.0 mm and may be polymer, fiber, leather, foil and the like.

Two opposing fixed surface tool halves (molds) mechanically stretch the materials to a predetermined shape, then air pressure is applied over the surface of a facing material, the substrate, or both, to execute the bond between the substrate and the one or more laminate. Two tool halves, each with a geometric surface, are made such that the periphery creates a “seal” on the outer layers of material. Internal porting on the tool is used to apply pressure. A face material and substrate may be assembled in a frame and heated and formed together or the process may be adapted to a step process in which bonding of the laminate layer(s) or face good is effected over a preformed substrate.

The prior methods of compression forming and bonding essentially squash the materials until all surfaces can contact each other to achieve the necessary pressure to effect bonding between the surfaces of adjacent layers. Greater pressure is required for stiffer materials. However, if an open cell foam, such as a fabric or foam backed vinyl, is used, the compression property of the foam may provide a pressure coverage necessary for bonding. Such prior methods require high compression forces, 45-75 psi or greater, up to 2000 psi. The present system uses approximately 3 psi to approximately 5 psi to approximately 15 psi, dependent on material and design parameters to achieve acceptable bonding in a contoured laminate product.

The present system results in less wear on tools and allows less expensive materials to be used in tool construction to provide a better product in appearance, with similar durability. Investment costs for capital equipment are reduced. The pressure contour bonding system employs air pressure to “fill” the gaps between the mold tool and component surfaces and has as an objective the provision of a bonding pressure over 100% of the surface area. Conventional molding can be characterized as “squashing” the materials together, requiring high compression tonnages. Reducing the forming tonnage, or squashing, maximizes the resulting cross-sectional thickness of the material and thus provides a stronger part. Lower tonnage also reduces wear on the tooling which provides greater durability enabling tooling to be produced at a lower cost. Reduced investment cost for tooling and equipment is achieved, as the tooling and equipment requires less clamp force.

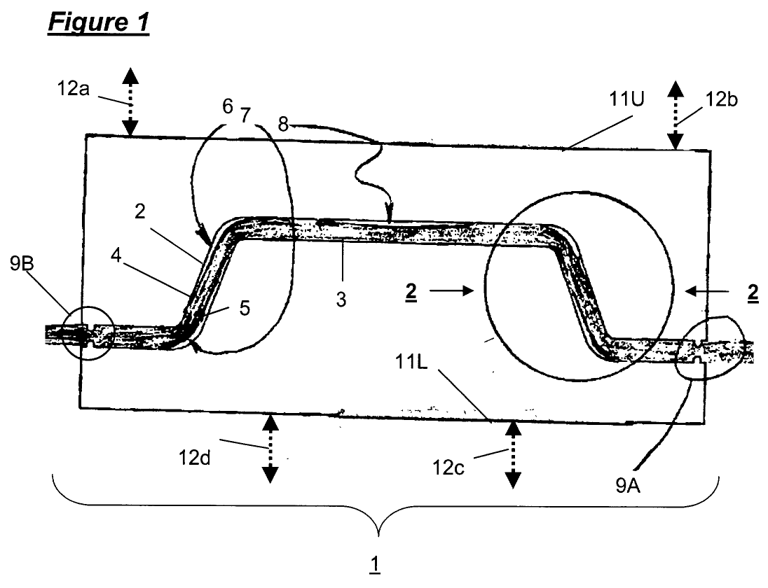

As shown in FIG. 1, a mold 1 of a desired vehicle interior trim component shape, for example, a headliner, pillar A, pillar B, or back wall liner, is provided. The mold comprises a cooperative female shell 2 and male shell 3, either of which may correspond to the finished (facing) surface of the desired shaped component. The molds are included in a frame having upper and lower sections, indicated figuratively in FIG. 1 as 11U and 11L. The respective halves of the mold/frame assembly are conjoiningly aligned and are capable of relative movement toward and apart from each other as shown by the bidirectional arrows 12a, 12b, 12c and 12d, typically by a powered mechanism such as by a hydraulic, pneumatic, or mechanically actuated device. The mold cavity defines a three-dimensional shape corresponding to a desired shape of a component. In an example of the process, the substrate 4, such as a PPF panel approximately 4 mm in thickness and a pliable face good 5 approximately 2 mm in thickness, are pinched or otherwise sealed, at their periphery/perimeter 9A and 9B to create a pressure seal. The mold presses the substrate and face good assembly approximately into the desired three-dimensional shape; however, interstices or gaps between the interior mold surfaces and the substrate and face good laminate assembly, such as at 6, 7 and 8 will typically occur. Conventionally, added pressure and squeezing is necessary to enclose the laminate in the mold to achieve sufficient bonding force through the full area of the part. In the system described herein, air pressure provides the bonding force to seal the face good to the desired surface of the substrate.

Before forming, the backing may be pre-coated with an adhesive, for example, after the PPF panel is extruded. Alternatively, an adhesive may be applied to the backing surface as a step in the overall forming process. Examples are low or no-flow adhesives, such as a dry film acrylic.

In one example of the forming process, the backing is heated before forming, to the heat activation temperature of the thermoformable material, in the instance of a 4 mm PPF substrate base panel, for approximately 1 to 2 minutes at approximately 350° to 400° F., to obtain sufficient pliability in the molding process. Alternatively, the substrate base panel may be preformed. The face good determines the surface appearance of the product and is determined at the discretion of a designer. Typically, the face good applied to the backing or substrate may comprise a synthetic or natural material, including vinyls, textiles, leather, foil, or the like, having a thickness in the range of up to about 2 mm or more, depending on design preference. The layers to be bonded are assembled in order and maintained in a frame and positioned between mold shells. When the mold is closed, the substrate and the face good and the intermediate laminate layers, if any, are pressed toward each other in sandwich fashion between the mold halves. In an optimum example of contoured mold halves A and B on the opposite sides of a material laminate 6 mm thick, when closed, tool half A is offset by the material thickness, 6 mm, to tool half B. In current practice with contoured pieces, the optimum is not achieved and gaps between the opposite exterior surfaces of the layered assembly and the mold shells on either side occur on one or both sides of the laminate as shown at 6, 7 and 8 in FIG. 1. The surface to which air pressure is applied needs to be essentially impermeable to gas/air flow to maintain a suitable pressure during the process. In the case of PPF and vinyl, impermeability results from inherent characteristics of the material. In the case of IBC, cloth, etc., typically the impermeable barrier is added as a closed cell polypropylene or urethane foam perimeter boundary around the part.

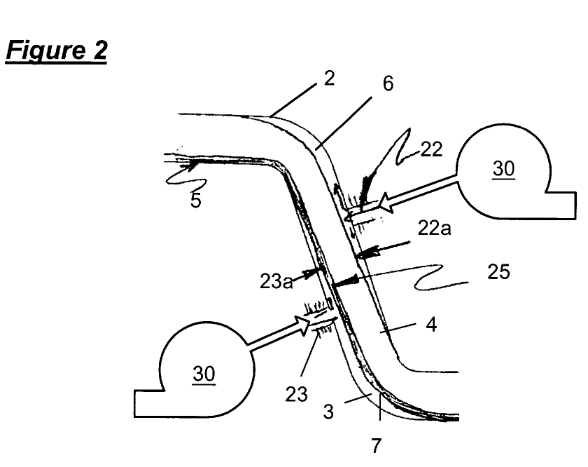

With reference to the detail shown in FIG. 2, showing the substrate 4 and face material 5 enclosed in the mold halves 2 and 3, either or both mold halves are provided with one or more orifices to receive compressed gas, such as 22 and 23 from compressor 30, or other source of pressurized gas, which distributes itself, arrows 22a and 23a, to fill the interstices, for example 6 and 7, whereby air/gas pressure between the mold faces and the respective substrate and face good provides sufficient bonding force to secure the face good to the adhesive surface of the substrate at their conjunction or bond line 25. The mold comprises a seal that allows air pressure to be increased within any interstices or spaces between the outer surfaces of the laminate layers and respective facing surfaces of the mold shells. Sealing techniques include inherent, static, mechanical and non-mechanical seals. The material may be pinched at the periphery of the shells to maintain a sealed environment within the area between the shells. A gas, such as compressed air, nitrogen or the like, is introduced into the spaces through a port, or plurality of ports located in one or both mold shells. The ports communicate with the spaces and are attached to the gas supply. The increase in air/gas pressure in the space between the laminate assembly and the mold shell presses the laminate materials together and closes any gap that may be present, reducing or eliminating voids, wrinkles and other imperfections. The time during which pressure is maintained is dependent upon pressure, thickness, temperature, bonding characteristics, and other manufacturing variables. An example for a PPF substrate and a vinyl face good bonded with a heat activated epoxy resin is in the range of approximately 2 minutes at a maximum of approximately 15 psi.

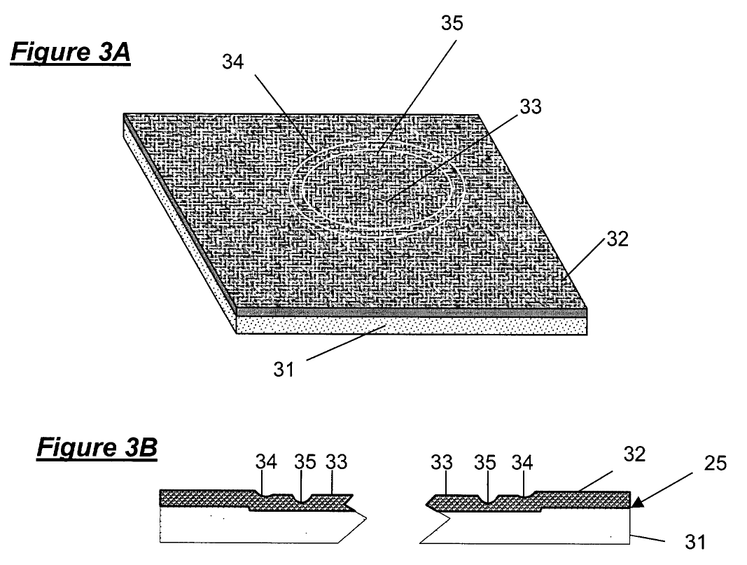

The positive air pressure for the extended period is sufficient to result in consistency in the material thickness and the desired definition in the component. For example, a component formed by the process for use in a motor vehicle as a trim panel for an air vent may include a definition of the opening to be removed for placement of the vent. In this regard, the compression molding process is conventionally employed to provide an impressed physical shape in the substrate, such as a relief, or impression area definitions for vents, speakers, lights, accessories, controls and the like. With reference to FIGS. 3A and 3B, a face good 32 is bonded to a substrate 31; relief indentations 34 and 35 define an accessory opening 33 which is subsequently cut out. Where such physical impressions in the substrate are involved, the molds are pressed together to make the required relief detail on the substrate surface, and pressured gas is introduced to provide the bonding force between the substrate, in this instance, having surface definitions, and the laminate layer(s) and/or face good, resulting in improved adhesion and better definition on the surface to be exposed to the vehicle interior.

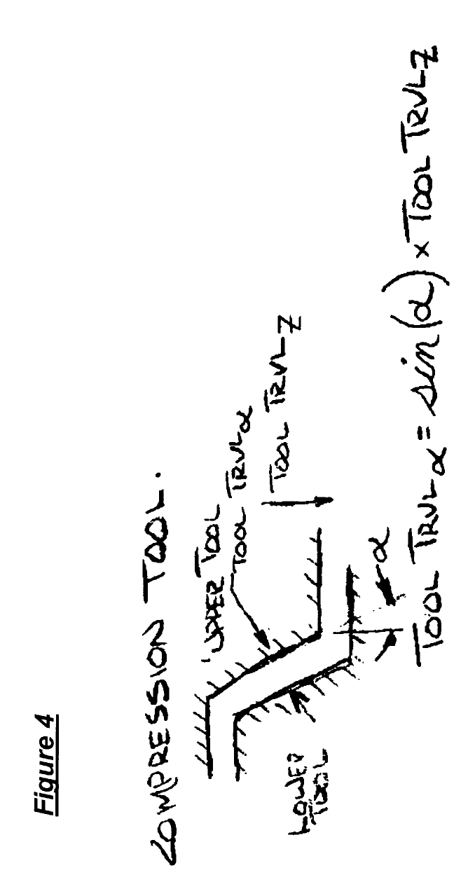

After processing, the air pressure is normalized and mold is opened to allow removal of the component. Components range in size and shapes to accommodate the needs of industry using contour molded parts. For example, the mold may be tooled to accept a backing with small dimensions to a backing having a dimension of up to about 72 inches by about 90 inches with a draw depth from nominal up to approximately about 15 to about 18 inches. Typical applications are for contoured headliners, rear wall panels, pillar A and pillar B in heavy duty vehicles. In the present system, as an angle becomes sharper, the advantage of pressure assisted bonding over physical compression is evident as physical force in a mold system cannot effectively be delivered transverse to a plane. The more aggressive the shape geometry is, greater mechanical compression is required to achieve acceptable bonding. The system accommodates to steep side walls that are a common problem with compression bonding. With steep side walls, materials are often at their thinnest and 1:1 movement on the compression tool is not obtainable as shown in FIG. 4. The advantages of using the present pressure bonding system to accommodate variations in material thickness and produce a laminate with improved properties are evident.

### EXAMPLE

A backing comprising an adhesive faced PPF substrate base of a thickness of about 4 mm is positioned within a clamp frame and heated to a temperature from about 350° F. to about 400° F. for about 1.5 minutes to about 2.0 minutes. A face material, such as a vinyl sheet with a thickness of about 2 mm is positioned in a planar relationship with respect to the top of the side of the PPF having an adhesive surface. The mold is closed and air pressure is introduced into the space between the mold shell and the back side of the base and the opposite mold shell and the front side of the face material for a sufficient time to achieve bonding. The air pressure is maintained for a time sufficient to achieve bonding between the substrate and face material, dependent on the adhesive type, temperature, base and face thickness, pressure, and other variables. Heating times are a function of the equipment and materials used dependent on variables such as temperature, conductivity, thickness, etc., For example, heat times may be as low as 35 seconds. Cooling time is similarly dependent on the aforementioned variables.

While the invention is described in detail with specific reference to certain embodiments and alternatives, it is not intended that the description limit the invention disclosed to a particular embodiment or specific alternatives. The scope of the invention is defined by the following claims.

1. A system for molding a laminate having a thermoformed substrate base and at least one laminate layer material comprising:
a mold having the predetermined shape, said mold comprising a male shell and a corresponding female shell;
a laminate assembly positioned intermediate the mold shells, the laminate assembly comprising a substrate base aligned proximate to and in a mating relationship with one or more than one laminate layer material;
an adhesive at the interface between a surface of the substrate base and a laminate layer, and, in the instance of more than one laminate layer, each interface between the surfaces of adjacent laminate layers;
means for closing the male and female mold shells in a direction toward the laminate assembly; and
means for applying a positive gas pressure through one or more orifices in at least one of the mold shells such that the substrate base and the one or more than one laminate layer are directed into contact at each interface of adjacent surfaces thereof with a force sufficient to adhesively bond the assembly.

2. The system of claim 1 including means for heating one of the thermoformable substrate base and the laminate assembly.

3. The system of claim 1 wherein the laminate assembly includes a substrate base preformed into the predetermined shape,

4. The system of claim 1 wherein adhesive is pre-coated on the surface of the substrate facing a laminate.

5. The system of claim 1 wherein a surface of a laminate is pre-coated with an adhesive.

6. The system of claim 2 wherein the adhesive is a dry film acrylic.

7. The system of claim 2 wherein the substrate base includes a precoated surface coating of a heat activated adhesive and the substrate is bonded to a face good.

8. The system of claim 1 including a means for compressing the periphery of the substrate and the laminate material to create a pressure seal.

9. The system of claim 1 in which in closing the mold shells, a nominal offset between the shell halves of approximately the thickness of the laminate is maintained.

10. The system of claim 1 in which gas pressure is introduced to a shell through a port that is operatively interconnected to a regulated source of compressed air.

11. The system of claim 10 in which air pressure in the range of from about 3 psi to about 15 psi is maintained for up to about 2.0 minutes during the time in which the mold shells are closed.

12. The system of claim 1 including a contoured mold.

13. An assembly for molding a contoured laminated trim component for a vehicle comprising:
a moveable male shell;
a moveable female shell cooperatively aligned with the male shell;
a moveable female shell cooperatively aligned with the male shell;
a heating element;
a frame for maintaining a laminate assembly comprising a substrate and one or more laminate layers to form the laminate in a position between the male shell and the female shell;
a means to provide a seal extending around the assembly;
at least one port formed in at least one of the shells, said port communicating from a source of compressed air to create a positive pressure in a space formed when the shells are closed.

14. In a system for molding a vehicle trim laminate having a thermoformed substrate and a face good applied thereon into a predetermined shape, the improvement comprising:
providing a contoured mold shape with contours separating adjacent planar sections of the shape, said mold comprising a male shell and a corresponding female shell in a cooperative alignment;
positioning a substantially planar thermoformable substrate having an adhesive coating on one surface thereof adjacent one of the shells with said adhesive coated surface facing opposite the surface adjacent to the shell;
heating the substrate;
positioning a face good between the surface of the substrate having an adhesive coating on one surface thereof and the other shell of the mold;
closing the mold shells to an offset distance of the material laminate thickness;
applying a positive gas pressure to one or both of the face good and the substrate facing the shells of the mold through at least one port in the shells; and
maintaining the pressure until the face good is bonded to the substrate.
